(19) United States
(12) Patent Application Publication
(10) Pub. No.: US 2026/0098194 A1
(43) Pub. Date: Apr. 9, 2026

(54) ADHESIVE COMPOSITION AND METHODS OF FORMING THE SAME

(71) Applicant: SAINT-GOBAIN PERFORMANCE PLASTICS CORPORATION, Malvern, PA (US)

(72) Inventors: Cassandra T. TUBBS, Boylston, MA (US); Shuai LIANG, Southborough, MA (US); Jeffrey H. PEET, Southborough, MA (US); Yubo CUI, Shrewsbury, MA (US); Hongbo FU, Zhengzhou (CN); Chang LIU, Troy, NY (US); Hua WANG, Northbridge, MA (US)

(21) Appl. No.: 19/347,925

(22) Filed: Oct. 2, 2025

Related U.S. Application Data
(60) Provisional application No. 63/703,393, filed on Oct. 4, 2024.

(51) Int. Cl. C09J 183/04; C08G 77/00; C08G 77/04; C08G 77/08; C08L 83/04; C09J 5/00

(52) U.S. Cl. CPC C09J 183/04; C08G 77/045; C08G 77/08; C08G 77/70; C08L 83/04; C09J 5/00; C09J 2483/00

(57) ABSTRACT

A solventless pressure sensitive adhesive may include a silicone-based diluent component, an MQ resin component, a vinyl silicone component, and a crosslinker component. The silicone-based diluent component content may be at least about 0.1 wt. % and not greater than about 14 wt. % for a total weight of the solventless pressure sensitive adhesive, the MQ resin component content may be at least about 30 wt. % and not greater than about 65 wt. % for a total weight of the solventless pressure sensitive adhesive, the vinyl silicone component content may be at least about 27 wt. % and not greater than about 62 wt. % for a total weight of the solventless pressure sensitive adhesive, and the crosslinker component content may be at least about 0.5 wt. % and not greater than about 8.0 wt. % for a total weight of the solventless pressure sensitive adhesive.

### CROSS-REFERENCE TO RELATED APPLICATION(S)

This application claims priority under 35 U.S.C. § 119 (c) to U.S. Provisional Patent Application No. 63/703,393 entitled “ADHESIVE COMPOSITION AND METHODS OF FORMING THE SAME,” filed Oct. 4, 2024, by Cassandra T. TUBBS et al., which is assigned to the current assignee hereof and is incorporated herein by reference in its entirety.

### FIELD OF THE DISCLOSURE

The present disclosure relates to an adhesive composition and methods of forming the same. The present disclosure further relates to a solventless pressure sensitive adhesive and methods of forming the same.

### BACKGROUND

Pressure sensitive adhesives and, in particular, silicon-based pressure sensitive adhesives are used in a number of industrial and consumer markets. Typical silicone-based pressure sensitive adhesive formulations require solvents to be able to be mix the resin and require high temperatures for curing. The solvents used for silicone-based pressure sensitive adhesives are highly flammable, can have negative health effects due to frequent exposure, and require high energy usage due to high temperature thermal curing processes. Therefore, there is a strong need to develop solventless silicone-based pressure sensitive adhesive compositions that retain high overall performance.

### SUMMARY

According to a first aspect, a solventless pressure sensitive adhesive may include a silicone-based diluent component, an MQ resin component, a vinyl silicone component, and a crosslinker component. The silicone-based diluent component may be present at a content of at least about 0.1 wt. % and not greater than about 14 wt. % for a total weight of the solventless pressure sensitive adhesive. The MQ resin component may be present at a content of at least about 30 wt. % and not greater than about 65 wt. % for a total weight of the solventless pressure sensitive adhesive. The vinyl silicone component may be present at a content of at least about 27 wt. % and not greater than about 62 wt. % for a total weight of the solventless pressure sensitive adhesive. The crosslinker component may be present at a content of at least about 0.5 wt. % and not greater than about 8.0 wt. % for a total weight of the solventless pressure sensitive adhesive.

According to another aspect, a solventless pressure sensitive adhesive may be formed from a solventless pressure sensitive adhesive precursor mixture. The solventless pressure sensitive adhesive precursor mixture may include a precursor silicone-based diluent component, a precursor MQ resin component, a precursor vinyl silicone component, and a precursor crosslinker component. The precursor silicone-based diluent component may be present at a content of at least about 0.1 wt. % and not greater than about 14 wt. % for a total weight of the solventless pressure sensitive adhesive. The precursor MQ resin component may be present at a content of at least about 30 wt. % and not greater than about 65 wt. % for a total weight of the solventless pressure sensitive adhesive. The precursor vinyl silicone component may be present at a content of at least about 27 wt. % and not greater than about 62 wt. % for a total weight of the solventless pressure sensitive adhesive. The precursor crosslinker component may be present at a content of at least about 0.5 wt. % and not greater than about 8.0 wt. % for a total weight of the solventless pressure sensitive adhesive.

According to still another aspect, a method of forming a solventless pressure sensitive adhesive may include providing a solventless pressure sensitive adhesive precursor mixture, mixing the solventless pressure sensitive adhesive precursor mixture, and curing the precursor MQ resin component and precursor vinyl silicone oil component to form the solventless pressure sensitive adhesive. The solventless pressure sensitive adhesive precursor mixture may include a precursor silicone-based diluent component, a precursor MQ resin component, a precursor vinyl silicone component, and a precursor crosslinker component. The precursor silicone-based diluent component may be present at a content of at least about 0.1 wt. % and not greater than about 14 wt. % for a total weight of the solventless pressure sensitive adhesive. The precursor MQ resin component may be present at a content of at least about 30 wt. % and not greater than about 65 wt. % for a total weight of the solventless pressure sensitive adhesive. The precursor vinyl silicone component may be present at a content of at least about 27 wt. % and not greater than about 62 wt. % for a total weight of the solventless pressure sensitive adhesive. The precursor crosslinker component may be present at a content of at least about 0.5 wt. % and not greater than about 8.0 wt. % for a total weight of the solventless pressure sensitive adhesive.

### BRIEF DESCRIPTION OF THE DRAWINGS

Embodiments are illustrated by way of example and are not limited to the accompanying figures.

FIG. 1 includes a diagram showing a solventless pressure sensitive adhesive forming method according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a solventless pressure sensitive adhesive (PSA) composition and methods of forming an adhesive composition.

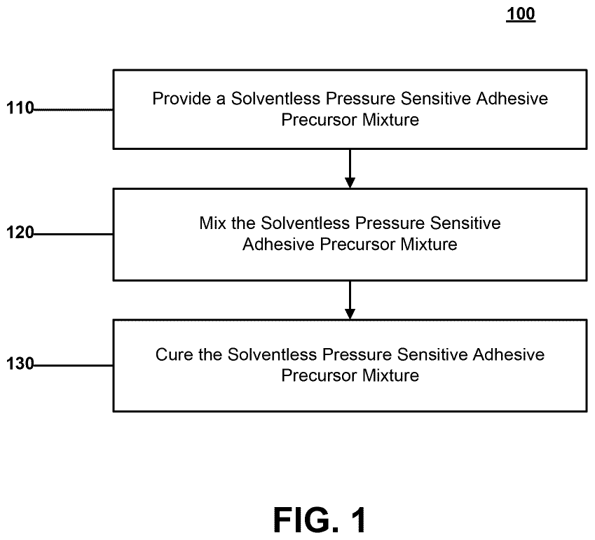

For purposes of illustration, FIG. 1 includes a diagram showing a solventless pressure sensitive adhesive forming method 100 according to particular embodiments described herein. The solventless pressure sensitive adhesive forming method 100 may include a first step 110 of providing a solventless pressure sensitive adhesive precursor mixture, a second step 120 of mixing the solventless pressure sensitive adhesive precursor mixture, and a third step 130 of curing the solventless pressure sensitive adhesive precursor mixture to form the solventless pressure sensitive adhesive.

It will be appreciated that the term “solventless” as used herein refers to a pressure sensitive adhesive that is formed in the absence of or without the use of a solvent.

Referring to the first step 110, according to certain embodiments, the solventless pressure sensitive adhesive precursor mixture may include a precursor silicone-based diluent component, a precursor MQ resin component, a precursor vinyl silicone component, and a precursor crosslinker component.

According to certain embodiments, the precursor diluent component may include a silicone-based precursor diluent component. According to yet other embodiments, the precursor diluent component may consist essentially of a silicone-based precursor diluent component. According to yet other embodiments, the precursor diluent component may include a monovinyl terminated polydimethylsiloxane. According to still other embodiments, the precursor diluent component may consist essentially of a monovinyl terminated polydimethylsiloxane. According to yet other embodiments, the precursor diluent component may include an organic-based precursor diluent component. According to still other embodiments, the precursor diluent component may consist essentially of an organic-based precursor diluent component.

According to yet other embodiments, the precursor diluent component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the precursor diluent component may have a molecular weight of at least about 5000 g/mol, such as, at least about 5250 g/mol or at least about 5500 g/mol or at least about 5750 g/mol or at least about 6000 g/mol or at least about 6250 g/mol or at least about 6500 g/mol or at least about 6750 g/mol or at least about 7000 g/mol or at least about 7250 g/mol or at least about 7500 g/mol or at least about 7750 g/mol or at least about 8000 g/mol or at least about 8250 g/mol or at least about 8500 g/mol or at least about 8750 g/mol or at least about 9000 g/mol or at least about 9250 g/mol or at least about 9500 g/mol or at least about 9750 g/mol or at least about 10000 g/mol or at least about 10250 g/mol or at least about 10500 g/mol or at least about 10750 g/mol or at least about 11000 g/mol or at least about 11250 g/mol or at least about 11500 g/mol or at least about 11750 g/mol or even at least about 12000 g/mol. According to yet other embodiments, the precursor diluent component may have a molecular weight of not greater than about 28000 g/mol, such as, not greater than about 27750 g/mol or not greater than about 27500 g/mol or not greater than about 27250 g/mol or not greater than about 27000 g/mol or not greater than about 26750 g/mol or not greater than about 26500 g/mol or not greater than about 26250 g/mol or not greater than about 26000 g/mol or not greater than about 25750 g/mol or not greater than about 25500 g/mol or not greater than about 25250 g/mol or not greater than about 25000 g/mol or not greater than about 24750 g/mol or not greater than about 24500 g/mol or not greater than about 24250 g/mol or not greater than about 24000 g/mol or not greater than about 23750 g/mol or not greater than about 23500 g/mol or not greater than about 23250 g/mol or not greater than about 23000 g/mol or not greater than about 22750 g/mol or not greater than about 22500 g/mol or not greater than about 22250 g/mol or not greater than about 22000 g/mol or not greater than about 21750 g/mol or not greater than about 21500 g/mol or not greater than about 21250 g/mol or not greater than about 21000 g/mol or not greater than about 21750 g/mol or not greater than about 21500 g/mol or not greater than about 21250 g/mol or not greater than about 21000 g/mol or not greater than about 20750 g/mol or not greater than about 20500 g/mol or not greater than about 20250 g/mol or even not greater than about 20000 g/mol. It will be appreciated that the molecular weight of the precursor diluent component may be within a range between any of the minimum and maximum values noted above. It will be further appreciated that the molecular weight of the precursor diluent component may be any value between any of the minimum and maximum values noted above.

According to still other embodiments, the solventless pressure sensitive adhesive precursor mixture may include the precursor diluent component at a particular content. For example, the solventless pressure sensitive adhesive precursor mixture may include the precursor diluent component at a content of at least about 0.1 wt. % for a total weight of the solventless pressure sensitive adhesive precursor mixture, such as, at least about 0.2 wt. % or at least about 0.3 wt. % or at least about 0.4 wt. % or at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to still other embodiments, the solventless pressure sensitive adhesive precursor mixture may include the precursor diluent component at a content of not greater than about 14 wt. % for a total weight of the solventless pressure sensitive adhesive precursor mixture, such as, not greater than about 13.5 wt. % or not greater than about 13.0 wt. % or not greater than about 12.5 wt. % or not greater than about 12.0 wt. % or not greater than about 11.5 wt. % or not greater than about 11.0 wt. % or not greater than about 10.5 wt. % or not greater than about 10.0 wt. % or not greater than about 9.5 wt. % or even not greater than about 9.0 wt. %. It will be appreciated that the solventless pressure sensitive adhesive precursor mixture may include the precursor diluent component at a content within a range between any of the minimum and maximum values noted above. It will be further appreciated that the solventless pressure sensitive adhesive precursor mixture may include the precursor diluent component at a content of any value between any of the minimum and maximum values noted above.

According to certain embodiments, the precursor MQ resin component may have a particular OH content. For example, the precursor MQ resin component may have an OH content of at least about 0.3%, such as, at least about 0.4% or at least about 0.5% or at least about 0.6% or at least about 0.7% or at least about 0.8% or at least about 0.9% or even at least about 1.0%. According to still other embodiments, the precursor MQ resin component may have an OH content of not greater than about 2.0%, such as, not greater than about 1.9% or not greater than about 1.8% or not greater than about 1.7% or not greater than about 1.6% or not greater than about 1.5% or not greater than about 1.4% or not greater than about 1.3% or even not greater than about 1.2%. It will be appreciated that the OH content of the precursor MQ resin component may be within a range between any of the minimum and maximum values noted above. It will be further appreciated that the OH content of the precursor MQ resin component may be any value between any of the minimum and maximum values noted above.

According to certain embodiments, the precursor MQ resin component may have a particular M/Q ratio. For example, the precursor MQ resin component may have an M/Q ratio of at least about 0.6, such as, at least about 0.63 or at least about 0.65 or at least about 0.68 or even at least about 0.70. According to still other embodiments, the precursor MQ resin component may have an M/Q ratio of not greater than about 0.80, such as, not greater than about 0.78 or not greater than about 0.75 or even not greater than about 0.73. It will be appreciated that the M/Q ratio of the precursor MQ resin component may be within a range between any of the minimum and maximum values noted above. It will be further appreciated that the M/Q ratio of the precursor MQ resin component may be any value between any of the minimum and maximum values noted above.

According to yet other embodiments, the precursor MQ resin component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the precursor MQ resin component may have a molecular weight of at least about 3000 g/mol, such as, at least about 3250 g/mol or at least about 3500 g/mol or at least about 3750 g/mol or at least about 4000 g/mol or at least about 4250 g/mol or at least about 4500 g/mol or at least about 4750 g/mol or at least about 5000 g/mol or at least about 5250 g/mol or at least about 5500 g/mol or at least about 5750 g/mol or at least about 6000 g/mol or at least about 6250 g/mol or at least about 6500 g/mol or at least about 6750 g/mol or at least about 7000 g/mol or at least about 7250 g/mol or even at least about 7500 g/mol. According to yet other embodiments, the precursor MQ resin component may have a molecular weight of not greater than about 10000 g/mol, such as, not greater than about 9750 g/mol or not greater than about 9500 g/mol or not greater than about 9250 g/mol or not greater than about 9000 g/mol or not greater than about 8750 g/mol or not greater than about 8500 g/mol or not greater than about 8250 g/mol or not greater than about 8000 g/mol or even not greater than about 7750 g/mol. It will be appreciated that the molecular weight of the precursor MQ resin component may be within a range between any of the minimum and maximum values noted above. It will be further appreciated that the molecular weight of the precursor MQ resin component may be any value between any of the minimum and maximum values noted above.

According to still other embodiments, the solventless pressure sensitive adhesive precursor mixture may include the precursor MQ resin component at a particular content. For example, the solventless pressure sensitive adhesive precursor mixture may include the precursor MQ resin component at a content of at least about 30 wt. % for a total weight of the solventless pressure sensitive adhesive precursor mixture, such as, at least about 33 wt. % or at least about 35 wt. % or at least about 37 wt. % or at least about 40 wt. % or at least about 43 wt. % or even at least about 45 wt. %. According to still other embodiments, the solventless pressure sensitive adhesive precursor mixture may include the precursor MQ resin component at a content of not greater than about 60 wt. % for a total weight of the solventless pressure sensitive adhesive precursor mixture, such as, not greater than about 58 wt. % or not greater than about 55 wt. % or not greater than about 53 wt. % or not greater than about 50 wt. % or even not greater than about 48 wt. %. It will be appreciated that the solventless pressure sensitive adhesive precursor mixture may include the precursor MQ resin component at a content within a range between any of the minimum and maximum values noted above. It will be further appreciated that the solventless pressure sensitive adhesive precursor mixture may include the precursor MQ resin component at a content of any value between any of the minimum and maximum values noted above.

According to certain embodiments, the precursor vinyl silicone component may include a vinyl terminated polydimethylsiloxane. According to yet other embodiments, the precursor vinyl silicone component may consist essentially of a vinyl terminated polydimethylsiloxane.

According to yet other embodiments, the precursor vinyl silicone component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the precursor vinyl silicone component may have a molecular weight of at least about 28000 g/mol, such as, at least about 28250 g/mol or at least about 28500 g/mol or at least about 28750 g/mol or at least about 29000 g/mol or at least about 29250 g/mol or at least about 29500 g/mol or at least about 29750 g/mol or at least about 30000 g/mol or at least about 30250 g/mol or at least about 30500 g/mol or at least about 30750 g/mol or at least about 31000 g/mol or at least about 31250 g/mol or at least about 31500 g/mol or at least about 31750 g/mol or at least about 32000 g/mol or at least about 32250 g/mol or at least about 32500 g/mol or at least about 32750 g/mol or at least about 33000 g/mol or at least about 33250 g/mol or at least about 33500 g/mol or at least about 33750 g/mol or at least about 34000 g/mol or at least about 34250 g/mol or at least about 34500 g/mol or at least about 34750 g/mol or even at least about 35000 g/mol. According to yet other embodiments, the precursor vinyl silicone component may have a molecular weight of not greater than about 72000 g/mol, such as, not greater than about 69750 g/mol or not greater than about 69500 g/mol or not greater than about 69250 g/mol or not greater than about 69000 g/mol or not greater than about 68750 g/mol or not greater than about 68500 g/mol or not greater than about 68250 g/mol or not greater than about 68000 g/mol or not greater than about 67750 g/mol or not greater than about 67500 g/mol or not greater than about 67250 g/mol or not greater than about 67000 g/mol or not greater than about 66750 g/mol or not greater than about 66500 g/mol or not greater than about 66250 g/mol or not greater than about 66000 g/mol or not greater than about 65750 g/mol or not greater than about 65500 g/mol or not greater than about 65250 g/mol or not greater than about 65000 g/mol or not greater than about 64750 g/mol or not greater than about 64500 g/mol or not greater than about 64250 g/mol or not greater than about 64000 g/mol or not greater than about 63750 g/mol or not greater than about 63500 g/mol or not greater than about 63250 g/mol or not greater than about 63000 g/mol or not greater than about 63750 g/mol or not greater than about 63500 g/mol or not greater than about 63250 g/mol or not greater than about 63000 g/mol or not greater than about 62750 g/mol or not greater than about 62500 g/mol or not greater than about 62250 g/mol or even not greater than about 62000 g/mol. It will be appreciated that the molecular weight of the precursor vinyl silicone component may be within a range between any of the minimum and maximum values noted above. It will be further appreciated that the molecular weight of the precursor vinyl silicone component may be any value between any of the minimum and maximum values noted above.

According to still other embodiments, the solventless pressure sensitive adhesive precursor mixture may include the precursor vinyl silicone component at a particular content. For example, the solventless pressure sensitive adhesive precursor mixture may include the precursor vinyl silicone component at a content of at least about 0.1 wt. % for a total weight of the solventless pressure sensitive adhesive precursor mixture, such as, at least about 27 wt. % or at least about 30 wt. % or at least about 33 wt. % or at least about 35 wt. % or at least about 37 wt. % or at least about 40 wt. % or at least about 43 wt. % or at least about 45 wt. % or at least about 47 wt. % or even at least about 50 wt. %. According to still other embodiments, the solventless pressure sensitive adhesive precursor mixture may include the precursor vinyl silicone component at a content of not greater than about 62 wt. % for a total weight of the solventless pressure sensitive adhesive precursor mixture, such as, not greater than about 60 wt. % or not greater than about 58 wt. % or not greater than about 55 wt. % or even not greater than about 52 wt. %. It will be appreciated that the solventless pressure sensitive adhesive precursor mixture may include the precursor vinyl silicone component at a content within a range between any of the minimum and maximum values noted above. It will be further appreciated that the solventless pressure sensitive adhesive precursor mixture may include the precursor vinyl silicone component at a content of any value between any of the minimum and maximum values noted above.

According to certain embodiments, the precursor crosslinker component may include a hydride silicone. According to yet other embodiments, the precursor crosslinker component may consist essentially of a hydride silicone. According to certain embodiments, the precursor crosslinker component may include polymethylhydrosiloxane, methylhydrosiloxane-dimethylsiloxane copolymers, trimethylsiloxy-terminated methylhydrosiloxane-dimethylsiloxane copolymers, hydride-terminated, or any combination thereof. According to yet other embodiments, the precursor crosslinker component may consist essentially of polymethylhydrosiloxane, methylhydrosiloxane-dimethylsiloxane copolymers, trimethylsiloxy-terminated methylhydrosiloxane-dimethylsiloxane copolymers, hydride-terminated, or any combination thereof.

According to yet other embodiments, the precursor crosslinker component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the precursor crosslinker component may have a molecular weight of at least about 1000 g/mol, such as, at least about 1250 g/mol or at least about 1500 g/mol or at least about 1750 g/mol or at least about 2000 g/mol or even at least about 2250 g/mol. According to yet other embodiments, the precursor crosslinker component may have a molecular weight of not greater than about 3000 g/mol, such as, not greater than about 2750 g/mol or not greater than about 2500 g/mol. It will be appreciated that the molecular weight of the precursor crosslinker component may be within a range between any of the minimum and maximum values noted above. It will be further appreciated that the molecular weight of the precursor crosslinker component may be any value between any of the minimum and maximum values noted above.

According to still other embodiments, the solventless pressure sensitive adhesive precursor mixture may include the precursor crosslinker component at a particular content. For example, the solventless pressure sensitive adhesive precursor mixture may include the precursor crosslinker component at a content of at least about 0.5 wt. % for a total weight of the solventless pressure sensitive adhesive precursor mixture, such as, at least about 1.0 wt. % or at least about 1.5 wt. % or at least about 2.0 wt. % or at least about 2.5 wt. % or at least about 3.0 wt. % or at least about 3.5 wt. % or even at least about 4.0 wt. %. According to still other embodiments, the solventless pressure sensitive adhesive precursor mixture may include the precursor crosslinker component at a content of not greater than about 8.0 wt. % for a total weight of the solventless pressure sensitive adhesive precursor mixture, such as, not greater than about 7.5 wt. % or not greater than about 7.0 wt. % or not greater than about 6.5 wt. % or even not greater than about 6.0 wt. %. It will be appreciated that the solventless pressure sensitive adhesive precursor mixture may include the precursor crosslinker component at a content within a range between any of the minimum and maximum values noted above. It will be further appreciated that the solventless pressure sensitive adhesive precursor mixture may include the precursor crosslinker component at a content of any value between any of the minimum and maximum values noted above.

According to still other embodiments, the solventless pressure sensitive adhesive precursor mixture may further include a precursor UV activated catalyst component.

According to still other embodiments, the precursor UV activated catalyst component may include a UV platinum catalyst, such as, bis(acetylacetonato)platinum(II), or trimethyl(methylcyclopentadienyl)(IV). According to yet other embodiments, the precursor UV activated catalyst component may consist essentially of a UV platinum catalyst, such as, bis(acetylacetonato)platinum(II), or trimethyl(methylcyclopentadienyl)(IV).

According to still other embodiments, the solventless pressure sensitive adhesive precursor mixture may include the precursor UV activated catalyst component at a particular content. For example, the solventless pressure sensitive adhesive precursor mixture may include the precursor UV activated catalyst component at a content of at least about 0.05 wt. % for a total weight of the solventless pressure sensitive adhesive precursor mixture, such as, at least about 0.1 wt. % or at least about 0.15 wt. % or at least about 0.2 wt. % or at least about 0.25 wt. % or at least about 0.3 wt. % or at least about 0.35 wt. % or even at least about 0.4 wt. %. According to still other embodiments, the solventless pressure sensitive adhesive precursor mixture may include the precursor crosslinker component at a content of not greater than about 1.0 wt. % for a total weight of the solventless pressure sensitive adhesive precursor mixture, such as, not greater than about 0.95 wt. % or not greater than about 0.90 wt. % or not greater than about 0.85 wt. % or even not greater than about 0.80 wt. %. It will be appreciated that the solventless pressure sensitive adhesive precursor mixture may include the precursor UV activated catalyst component at a content within a range between any of the minimum and maximum values noted above. It will be further appreciated that the solventless pressure sensitive adhesive precursor mixture may include the precursor UV activated catalyst component at a content of any value between any of the minimum and maximum values noted above.

According to still other embodiments, the solventless pressure sensitive adhesive precursor mixture may include the precursor thermally activated catalyst component at a particular content. For example, the solventless pressure sensitive adhesive precursor mixture may include the precursor thermally activated catalyst component at a content of at least about 0.05 wt. % for a total weight of the solventless pressure sensitive adhesive precursor mixture, such as, at least about 0.1 wt. % or at least about 0.15 wt. % or at least about 0.2 wt. % or at least about 0.25 wt. % or at least about 0.3 wt. % or at least about 0.35 wt. % or even at least about 0.4 wt. %. According to still other embodiments, the solventless pressure sensitive adhesive precursor mixture may include the precursor crosslinker component at a content of not greater than about 1.0 wt. % for a total weight of the solventless pressure sensitive adhesive precursor mixture, such as, not greater than about 0.95 wt. % or not greater than about 0.90 wt. % or not greater than about 0.85 wt. % or even not greater than about 0.80 wt. %. It will be appreciated that the solventless pressure sensitive adhesive precursor mixture may include the precursor thermally activated catalyst component at a content within a range between any of the minimum and maximum values noted above. It will be further appreciated that the solventless pressure sensitive adhesive precursor mixture may include the precursor thermally activated catalyst component at a content of any value between any of the minimum and maximum values noted above.

Referring now to the solventless pressure sensitive adhesive formed according to embodiments described herein, the solventless pressure sensitive adhesive may include a silicone-based diluent component, a MQ resin component, a vinyl silicone component, and a crosslinker component.

According to certain embodiments, the diluent component may include a silicone-based diluent component. According to yet other embodiments, the diluent component may consist essentially of a silicone-based diluent component. According to yet other embodiments, the diluent component may include a monovinyl terminated polydimethylsiloxane. According to still other embodiments, the diluent component may consist essentially of a monovinyl terminated polydimethylsiloxane. According to yet other embodiments, the diluent component may include an organic-based diluent component. According to still other embodiments, the diluent component may consist essentially of an organic-based diluent component.

According to yet other embodiments, the diluent component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the diluent component may have a molecular weight of at least about 5000 g/mol, such as, at least about 5250 g/mol or at least about 5500 g/mol or at least about 5750 g/mol or at least about 6000 g/mol or at least about 6250 g/mol or at least about 6500 g/mol or at least about 6750 g/mol or at least about 7000 g/mol or at least about 7250 g/mol or at least about 7500 g/mol or at least about 7750 g/mol or at least about 8000 g/mol or at least about 8250 g/mol or at least about 8500 g/mol or at least about 8750 g/mol or at least about 9000 g/mol or at least about 9250 g/mol or at least about 9500 g/mol or at least about 9750 g/mol or at least about 10000 g/mol or at least about 10250 g/mol or at least about 10500 g/mol or at least about 10750 g/mol or at least about 11000 g/mol or at least about 11250 g/mol or at least about 11500 g/mol or at least about 11750 g/mol or even at least about 12000 g/mol. According to yet other embodiments, the diluent component may have a molecular weight of not greater than about 28000 g/mol, such as, not greater than about 27750 g/mol or not greater than about 27500 g/mol or not greater than about 27250 g/mol or not greater than about 27000 g/mol or not greater than about 26750 g/mol or not greater than about 26500 g/mol or not greater than about 26250 g/mol or not greater than about 26000 g/mol or not greater than about 25750 g/mol or not greater than about 25500 g/mol or not greater than about 25250 g/mol or not greater than about 25000 g/mol or not greater than about 24750 g/mol or not greater than about 24500 g/mol or not greater than about 24250 g/mol or not greater than about 24000 g/mol or not greater than about 23750 g/mol or not greater than about 23500 g/mol or not greater than about 23250 g/mol or not greater than about 23000 g/mol or not greater than about 22750 g/mol or not greater than about 22500 g/mol or not greater than about 22250 g/mol or not greater than about 22000 g/mol or not greater than about 21750 g/mol or not greater than about 21500 g/mol or not greater than about 21250 g/mol or not greater than about 21000 g/mol or not greater than about 21750 g/mol or not greater than about 21500 g/mol or not greater than about 21250 g/mol or not greater than about 21000 g/mol or not greater than about 20750 g/mol or not greater than about 20500 g/mol or not greater than about 20250 g/mol or even not greater than about 20000 g/mol. It will be appreciated that the molecular weight of the diluent component may be within a range between any of the minimum and maximum values noted above. It will be further appreciated that the molecular weight of the diluent component may be any value between any of the minimum and maximum values noted above.

According to still other embodiments, the solventless pressure sensitive adhesive may include the diluent component at a particular content. For example, the solventless pressure sensitive adhesive may include the diluent component at a content of at least about 0.1 wt. % for a total weight of the solventless pressure sensitive adhesive, such as, at least about 0.2 wt. % or at least about 0.3 wt. % or at least about 0.4 wt. % or at least about 0.5 wt. % or at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or at least about 4.5 wt. % or at least about 5.0 wt. % or at least about 5.5 wt. % or at least about 6.0 wt. % or at least about 6.5 wt. % or even at least about 7.0 wt. %. According to still other embodiments, the solventless pressure sensitive adhesive may include the diluent component at a content of not greater than about 14 wt. % for a total weight of the solventless pressure sensitive adhesive, such as, not greater than about 13.5 wt. % or not greater than about 13.0 wt. % or not greater than about 12.5 wt. % or not greater than about 12.0 wt. % or not greater than about 11.5 wt. % or not greater than about 11.0 wt. % or not greater than about 10.5 wt. % or not greater than about 10.0 wt. % or not greater than about 9.5 wt. % or even not greater than about 9.0 wt. %. It will be appreciated that the solventless pressure sensitive adhesive may include the diluent component at a content within a range between any of the minimum and maximum values noted above. It will be further appreciated that the solventless pressure sensitive adhesive may include the diluent component at a content of any value between any of the minimum and maximum values noted above.

According to certain embodiments, the MQ resin component may have a particular OH content. For example, the MQ resin component may have an OH content of at least about 0.3%, such as, at least about 0.4% or at least about 0.5% or at least about 0.6% or at least about 0.7% or at least about 0.8% or at least about 0.9% or even at least about 1.0%. According to still other embodiments, the MQ resin component may have an OH content of not greater than about 2.0%, such as, not greater than about 1.9% or not greater than about 1.8% or not greater than about 1.7% or not greater than about 1.6% or not greater than about 1.5% or not greater than about 1.4% or not greater than about 1.3% or even not greater than about 1.2%. It will be appreciated that the OH content of the MQ resin component may be within a range between any of the minimum and maximum values noted above. It will be further appreciated that the OH content of the MQ resin component may be any value between any of the minimum and maximum values noted above.

According to certain embodiments, the MQ resin component may have a particular M/Q ratio. For example, the MQ resin component may have an M/Q ratio of at least about 0.6, such as, at least about 0.63 or at least about 0.65 or at least about 0.68 or even at least about 0.70. According to still other embodiments, the MQ resin component may have an M/Q ratio of not greater than about 0.80, such as, not greater than about 0.78 or not greater than about 0.75 or even not greater than about 0.73. It will be appreciated that the M/Q ratio of the MQ resin component may be within a range between any of the minimum and maximum values noted above. It will be further appreciated that the M/Q ratio of the MQ resin component may be any value between any of the minimum and maximum values noted above.

According to yet other embodiments, the MQ resin component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the MQ resin component may have a molecular weight of at least about 3000 g/mol, such as, at least about 3250 g/mol or at least about 3500 g/mol or at least about 3750 g/mol or at least about 4000 g/mol or at least about 4250 g/mol or at least about 4500 g/mol or at least about 4750 g/mol or at least about 5000 g/mol or at least about 5250 g/mol or at least about 5500 g/mol or at least about 5750 g/mol or at least about 6000 g/mol or at least about 6250 g/mol or at least about 6500 g/mol or at least about 6750 g/mol or at least about 7000 g/mol or at least about 7250 g/mol or even at least about 7500 g/mol. According to yet other embodiments, the MQ resin component may have a molecular weight of not greater than about 10000 g/mol, such as, not greater than about 9750 g/mol or not greater than about 9500 g/mol or not greater than about 9250 g/mol or not greater than about 9000 g/mol or not greater than about 8750 g/mol or not greater than about 8500 g/mol or not greater than about 8250 g/mol or not greater than about 8000 g/mol or even not greater than about 7750 g/mol. It will be appreciated that the molecular weight of the MQ resin component may be within a range between any of the minimum and maximum values noted above. It will be further appreciated that the molecular weight of the MQ resin component may be any value between any of the minimum and maximum values noted above.

According to still other embodiments, the solventless pressure sensitive adhesive may include the MQ resin component at a particular content. For example, the solventless pressure sensitive adhesive may include the MQ resin component at a content of at least about 30 wt. % for a total weight of the solventless pressure sensitive adhesive, such as, at least about 33 wt. % or at least about 35 wt. % or at least about 37 wt. % or at least about 40 wt. % or at least about 43 wt. % or even at least about 45 wt. %. According to still other embodiments, the solventless pressure sensitive adhesive may include the MQ resin component at a content of not greater than about 60 wt. % for a total weight of the solventless pressure sensitive adhesive, such as, not greater than about 58 wt. % or not greater than about 55 wt. % or not greater than about 53 wt. % or not greater than about 50 wt. % or even not greater than about 48 wt. %. It will be appreciated that the solventless pressure sensitive adhesive may include the MQ resin component at a content within a range between any of the minimum and maximum values noted above. It will be further appreciated that the solventless pressure sensitive adhesive may include the MQ resin component at a content of any value between any of the minimum and maximum values noted above.

According to certain embodiments, the vinyl silicone component may include a vinyl terminated polydimethylsiloxane. According to yet other embodiments, the vinyl silicone component may consist essentially of a vinyl terminated polydimethylsiloxane.

According to yet other embodiments, the vinyl silicone component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the vinyl silicone component may have a molecular weight of at least about 28000 g/mol, such as, at least about 28250 g/mol or at least about 28500 g/mol or at least about 28750 g/mol or at least about 29000 g/mol or at least about 29250 g/mol or at least about 29500 g/mol or at least about 29750 g/mol or at least about 30000 g/mol or at least about 30250 g/mol or at least about 30500 g/mol or at least about 30750 g/mol or at least about 31000 g/mol or at least about 31250 g/mol or at least about 31500 g/mol or at least about 31750 g/mol or at least about 32000 g/mol or at least about 32250 g/mol or at least about 32500 g/mol or at least about 32750 g/mol or at least about 33000 g/mol or at least about 33250 g/mol or at least about 33500 g/mol or at least about 33750 g/mol or at least about 34000 g/mol or at least about 34250 g/mol or at least about 34500 g/mol or at least about 34750 g/mol or even at least about 35000 g/mol. According to yet other embodiments, the vinyl silicone component may have a molecular weight of not greater than about 72000 g/mol, such as, not greater than about 69750 g/mol or not greater than about 69500 g/mol or not greater than about 69250 g/mol or not greater than about 69000 g/mol or not greater than about 68750 g/mol or not greater than about 68500 g/mol or not greater than about 68250 g/mol or not greater than about 68000 g/mol or not greater than about 67750 g/mol or not greater than about 67500 g/mol or not greater than about 67250 g/mol or not greater than about 67000 g/mol or not greater than about 66750 g/mol or not greater than about 66500 g/mol or not greater than about 66250 g/mol or not greater than about 66000 g/mol or not greater than about 65750 g/mol or not greater than about 65500 g/mol or not greater than about 65250 g/mol or not greater than about 65000 g/mol or not greater than about 64750 g/mol or not greater than about 64500 g/mol or not greater than about 64250 g/mol or not greater than about 64000 g/mol or not greater than about 63750 g/mol or not greater than about 63500 g/mol or not greater than about 63250 g/mol or not greater than about 63000 g/mol or not greater than about 63750 g/mol or not greater than about 63500 g/mol or not greater than about 63250 g/mol or not greater than about 63000 g/mol or not greater than about 62750 g/mol or not greater than about 62500 g/mol or not greater than about 62250 g/mol or even not greater than about 62000 g/mol. It will be appreciated that the molecular weight of the vinyl silicone component may be within a range between any of the minimum and maximum values noted above. It will be further appreciated that the molecular weight of the vinyl silicone component may be any value between any of the minimum and maximum values noted above.

According to still other embodiments, the solventless pressure sensitive adhesive may include the vinyl silicone component at a particular content. For example, the solventless pressure sensitive adhesive may include the vinyl silicone component at a content of at least about 0.1 wt. % for a total weight of the solventless pressure sensitive adhesive, such as, at least about 27 wt. % or at least about 30 wt. % or at least about 33 wt. % or at least about 35 wt. % or at least about 37 wt. % or at least about 40 wt. % or at least about 43 wt. % or at least about 45 wt. % or at least about 47 wt. % or even at least about 50 wt. %. According to still other embodiments, the solventless pressure sensitive adhesive may include the vinyl silicone component at a content of not greater than about 62 wt. % for a total weight of the solventless pressure sensitive adhesive, such as, not greater than about 60 wt. % or not greater than about 58 wt. % or not greater than about 55 wt. % or even not greater than about 52 wt. %. It will be appreciated that the solventless pressure sensitive adhesive may include the vinyl silicone component at a content within a range between any of the minimum and maximum values noted above. It will be further appreciated that the solventless pressure sensitive adhesive may include the vinyl silicone component at a content of any value between any of the minimum and maximum values noted above.

According to certain embodiments, the crosslinker component may include a hydride silicone. According to yet other embodiments, the crosslinker component may consist essentially of a hydride silicone. According to certain embodiments, the crosslinker component may include polymethylhydrosiloxane, methylhydrosiloxane-dimethylsiloxane copolymers, trimethylsiloxy-terminated methylhydrosiloxane-dimethylsiloxane copolymers, hydride-terminated, or any combination thereof. According to yet other embodiments, the crosslinker component may consist essentially of polymethylhydrosiloxane, methylhydrosiloxane-dimethylsiloxane copolymers, trimethylsiloxy-terminated methylhydrosiloxane-dimethylsiloxane copolymers, hydride-terminated, or any combination thereof.

According to yet other embodiments, the crosslinker component may have a particular molecular weight, where the molecular weight is defined as the number average molecular weight (Mn) and is measured using conventional Gel Permeation Chromatography (GPC), where 1) a Shimadzu Prominence LC-20AD system is connected with a RID-20A refractive Index Detector, 2) Toluene is used as a mobile phase, 3) the flow rate is set to 1 mL/min, and the oven temperature is set at 40° C., and 4) a calibration curve is created by 10 different polystyrene reference materials with known Mn. For example, the crosslinker component may have a molecular weight of at least about 1000 g/mol, such as, at least about 1250 g/mol or at least about 1500 g/mol or at least about 1750 g/mol or at least about 2000 g/mol or even at least about 2250 g/mol. According to yet other embodiments, the crosslinker component may have a molecular weight of not greater than about 3000 g/mol, such as, not greater than about 2750 g/mol or not greater than about 2500 g/mol. It will be appreciated that the molecular weight of the crosslinker component may be within a range between any of the minimum and maximum values noted above. It will be further appreciated that the molecular weight of the crosslinker component may be any value between any of the minimum and maximum values noted above.

According to still other embodiments, the solventless pressure sensitive adhesive may include the crosslinker component at a particular content. For example, the solventless pressure sensitive adhesive may include the crosslinker component at a content of at least about 0.5 wt. % for a total weight of the solventless pressure sensitive adhesive, such as, at least about 1.0 wt. % or at least about 1.5 wt. % or at least about 2.0 wt. % or at least about 2.5 wt. % or at least about 3.0 wt. % or at least about 3.5 wt. % or even at least about 4.0 wt. %. According to still other embodiments, the solventless pressure sensitive adhesive may include the crosslinker component at a content of not greater than about 8.0 wt. % for a total weight of the solventless pressure sensitive adhesive, such as, not greater than about 7.5 wt. % or not greater than about 7.0 wt. % or not greater than about 6.5 wt. % or even not greater than about 6.0 wt. %. It will be appreciated that the solventless pressure sensitive adhesive may include the crosslinker component at a content within a range between any of the minimum and maximum values noted above. It will be further appreciated that the solventless pressure sensitive adhesive may include the crosslinker component at a content of any value between any of the minimum and maximum values noted above.

According to certain embodiments, the solventless pressure sensitive adhesive may have a particular tack as measured at a thickness of at least about 1.3 mil and not greater than about 1.8 mil according to a probe tack testing method where a texture analyzer is used for tack testing of a samples using a flat stainless-steel probe, and the dwell time and speed debonding for all tests is 2 minutes and 10 mm/sec respectively. For example, the solventless pressure sensitive adhesive may have a tack of at least about 200 g, such as, at least about 250 g or at least 300 g or at least about 350 g or at least about 400 g or at least about 450 g or at least about 500 g or even at least about 550 g. According to still other embodiments, the solventless pressure sensitive adhesive may have a tack of not greater than about 1100 g, such as, not greater than about 1150 g or not greater than about 1100 g or not greater than about 1050 g or not greater than about 1000 g or not greater than about 950 g or not greater than about 900 g or not greater than about 850 g or not greater than about 800 g or even not greater than about 750 g. It will be appreciated that the solventless pressure sensitive adhesive may have a tack within a range between any of the minimum and maximum values noted above. It will be further appreciated that the solventless pressure sensitive adhesive may have a tack of any value between any of the minimum and maximum values noted above.

According to certain embodiments, the solventless pressure sensitive adhesive may have a particular peel strength as measured at a 180° peel angle using a pull speed of 5 mm/s using an IMass Peel Tester. Samples were prepared 24 hours before testing took place. For example, the solventless pressure sensitive adhesive may have a peel strength of at least about 0.2 N/cm, such as, at least about 0.4 N/cm or at least 0.6 N/cm or at least about 0.8 N/cm or at least about 1.0 N/cm or at least about 1.2 N/cm or at least about 1.4 N/cm or even at least about 1.6 N/cm. According to still other embodiments, the solventless pressure sensitive adhesive may have a peel strength of not greater than about 4.2 N/cm, such as, not greater than about 4.0 N/cm or not greater than about 3.8 N/cm or not greater than about 3.6 N/cm or not greater than about 3.4 N/cm or not greater than about 3.2 N/cm or not greater than about 3.0 N/cm or not greater than about 2.8 N/cm or not greater than about 2.6 N/cm or even not greater than about 2.4 N/cm. It will be appreciated that the solventless pressure sensitive adhesive may have a peel strength within a range between any of the minimum and maximum values noted above. It will be further appreciated that the solventless pressure sensitive adhesive may have a peel strength of any value between any of the minimum and maximum values noted above.

According to certain embodiments, the solventless pressure sensitive adhesive may have a particular shear adhesion failure temperature (SAFT) as measured according to PSTC-17, where a 3 inch by 1 inch sample applied to a stainless steel plate with a 30 minute dwell after preparation. The specimen is placed in a 40° C. oven with 2 kg weigh applied. The oven is programmed to be at 40° C. for 20 minutes, followed by a 0.5° C./min temperature ramp up to 200° C. The SAFT is the temperature at which the specimen separates from the stainless steel plate. According to particular embodiments, the solventless pressure sensitive adhesive may have a SAFT of at least about 160° C., such as, at least about 163° C. or at least about 165° C. or at least about 168° C. or at least about 170° C. or at least about 173° C. or at least about 175° C. or at least about 178° C. or at least about 180° C. or at least about 183° C. or at least about 185° C. or at least about 188° C. or at least about 190° C. or at least about 195° C. or even at least about 198° C. It will be appreciated that the solventless pressure sensitive adhesive may have a SAFT within a range between any of the values noted above. It will be further appreciated that the solventless pressure sensitive adhesive may have a SAFT of any value between any of the values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A solventless pressure sensitive adhesive (PSA) comprising: a silicone-based diluent component at a content of at least about 0.1 wt. % and not greater than about 14 wt. % for a total weight of the solventless pressure sensitive adhesive, an MQ resin component at a content of at least about 30 wt. % and not greater than about 65 wt. % for a total weight of the solventless pressure sensitive adhesive, a vinyl silicone component at a content of at least about 27 wt. % and not greater than about 62 wt. % for a total weight of the solventless pressure sensitive adhesive, and a crosslinker component at a content of at least about 0.5 wt. % and not greater than about 8.0 wt. % for a total weight of the solventless pressure sensitive adhesive.

Embodiment 2. A solventless pressure sensitive adhesive (PSA) formed from a solventless pressure sensitive adhesive precursor mixture, wherein the precursor mixture comprises: a precursor silicone-based diluent component at a content of at least about 0.1 wt. % and not greater than about 14 wt. % for a total weight of the precursor mixture, a precursor MQ resin component at a content of at least about 30 wt. % and not greater than about 65 wt. % for a total weight of the precursor mixture, a precursor vinyl silicone component at a content of at least about 27 wt. % and not greater than about 62 wt. % for a total weight of the precursor mixture, and a precursor crosslinker component at a content of at least about 0.5 wt. % and not greater than about 8.0 wt. % for a total weight of the precursor mixture.

Embodiment 3. A method of forming a solventless pressure sensitive adhesive (PSA), wherein the method comprises: providing a solventless pressure sensitive adhesive precursor mixture, wherein the precursor mixture comprises: a precursor silicone-based diluent component at a content of at least about 0.1 wt. % and not greater than about 14 wt. % for a total weight of the precursor mixture, a precursor MQ resin component at a content of at least about 30 wt. % and not greater than about 65 wt. % for a total weight of the precursor mixture, a precursor vinyl silicone component at a content of at least about 27 wt. % and not greater than about 62 wt. % for a total weight of the precursor mixture, and a precursor crosslinker component at a content of at least about 0.5 wt. % and not greater than about 8.0 wt. % for a total weight of the precursor mixture, mixing the precursor mixture, and curing the precursor to form the solventless pressure sensitive adhesive.

Embodiment 4. The solventless pressure sensitive adhesive (PSA) or method of any one of embodiments 1, 2, and 3, wherein the PSA comprises a tack of at least about 200 g.

Embodiment 5. The solventless pressure sensitive adhesive (PSA) or method of any one of embodiments 1, 2, and 3, wherein the PSA comprises a tack of not greater than about 1100 g.

Embodiment 6. The solventless pressure sensitive adhesive (PSA) or method of any one of embodiments 1, 2, and 3, wherein the PSA comprises a peel strength of at least about 0.2 N/cm as measured at a 180° peel angle.

Embodiment 7. The solventless pressure sensitive adhesive (PSA) or method of any one of embodiments 1, 2, and 3, wherein the PSA comprises a peel strength of not greater than about 4.2 N/cm as measured at a 180° peel angle.

Embodiment 8. The solventless pressure sensitive adhesive (PSA) or method of any one of embodiments 2 and 3, wherein the precursor MQ resin component has an OH content of at least about 0.3%.

Embodiment 9. The solventless pressure sensitive adhesive (PSA) or method of any one of embodiments 2 and 3, wherein the precursor MQ resin component has an OH content of not greater than about 2%.

Embodiment 10. The solventless pressure sensitive adhesive (PSA) or method of any one of embodiments 2 and 3, wherein the precursor MQ resin component has an M/Q ratio of at least about 0.6.

Embodiment 11. The solventless pressure sensitive adhesive (PSA) or method of any one of embodiments 2 and 3, wherein the precursor MQ resin component has an M/Q ratio of at not greater than about 0.8.

Embodiment 12. The solventless pressure sensitive adhesive (PSA) or method of any one of embodiments 2 and 3, wherein the precursor MQ resin component has molecular weight of at least about 3,000 g/mol.

Embodiment 13. The solventless pressure sensitive adhesive (PSA) or method of any one of embodiments 2 and 3, wherein the precursor MQ resin component has molecular weight of not greater than about 10,000 g/mol.

Embodiment 14. The solventless pressure sensitive adhesive (PSA) or method of any one of embodiments 1, 2, and 3, wherein the PSA comprises an MQ resin component at a content of at least about 30 wt. %.

Embodiment 15. The solventless pressure sensitive adhesive (PSA) or method of any one of embodiments 1, 2, and 3, wherein the PSA comprises an MQ resin component at a content of not greater than about 65 wt. %.

Embodiment 16. The solventless pressure sensitive adhesive (PSA) or method of any one of embodiments 1, 2, and 3, wherein the MQ resin component has an OH content of at least about 0.3%.

Embodiment 17. The solventless pressure sensitive adhesive (PSA) or method of any one of embodiments 1, 2, and 3, wherein the MQ resin component has an OH content of not greater than about 5%.

Embodiment 18. The solventless pressure sensitive adhesive (PSA) or method of any one of embodiments 1, 2, and 3, wherein the MQ resin component has an M/Q ratio of at least about 0.6.

Embodiment 19. The solventless pressure sensitive adhesive (PSA) or method of any one of embodiments 1, 2, and 3, wherein the MQ resin component has an M/Q ratio of at not greater than about 0.8.

Embodiment 20. The solventless pressure sensitive adhesive (PSA) or method of any one of embodiments 1, 2, and 3, wherein the MQ resin component has molecular weight of at least about 3,000 g/mol.

Embodiment 21. The solventless pressure sensitive adhesive (PSA) or method of any one of embodiments 1, 2, and 3, wherein the MQ resin component has molecular weight of not greater than about 10,000 g/mol.

Embodiment 22. The solventless pressure sensitive adhesive (PSA) or method of any one of embodiments 1, 2, and 3, wherein the precursor diluent component comprises a silicone-based precursor diluent component.

Embodiment 23. The solventless pressure sensitive adhesive (PSA) or method of any one of embodiments 1, 2, and 3, wherein the precursor diluent component comprises a monovinyl terminated polydimethylsiloxane.

Embodiment 24. The solventless pressure sensitive adhesive (PSA) or method of any one of embodiments 1, 2, and 3, wherein the precursor diluent component comprises a molecular weight of at least about 5000 g/mol.

Embodiment 25. The solventless pressure sensitive adhesive (PSA) or method of any one of embodiments 1, 2, and 3, wherein the precursor diluent component comprises a molecular weight of not greater than about 28000 g/mol.

Embodiment 26. The solventless pressure sensitive adhesive (PSA) or method of any one of embodiments 1, 2, and 3, wherein the precursor diluent component comprises an organic-based precursor diluent component.

Embodiment 27. The solventless pressure sensitive adhesive (PSA) or method of any one of embodiments 1, 2, and 3, wherein the PSA comprises a diluent component at a content of at least about 0.1 wt. %.

Embodiment 28. The solventless pressure sensitive adhesive (PSA) or method of any one of embodiments 1, 2, and 3, wherein the PSA comprises a diluent component at a content of not greater than about 14 wt. %.

Embodiment 29. The solventless pressure sensitive adhesive (PSA) or method of any one of embodiments 1, 2, and 3, wherein the diluent component comprises a silicone-based diluent component.

Embodiment 30. The solventless pressure sensitive adhesive (PSA) or method of any one of embodiments 1, 2, and 3, wherein the diluent component comprises a monovinyl terminated polydimethylsiloxane.

Embodiment 31. The solventless pressure sensitive adhesive (PSA) or method of any one of embodiments 1, 2, and 3, wherein the diluent component comprises a molecular weight of at least about 5000 g/mol.

Embodiment 32. The solventless pressure sensitive adhesive (PSA) or method of any one of embodiments 1, 2, and 3, wherein the diluent component comprises a molecular weight of not greater than about 28000 g/mol.

Embodiment 33. The solventless pressure sensitive adhesive (PSA) or method of any one of embodiments 1, 2, and 3, wherein the diluent component comprises an organic-based diluent component.

Embodiment 34. The solventless pressure sensitive adhesive (PSA) or method of any one of embodiments 1, 2, and 3, wherein the precursor vinyl silicone component comprises a vinyl terminated polydimethylsiloxane.

Embodiment 35. The solventless pressure sensitive adhesive (PSA) or method of any one of embodiments 1, 2, and 3, wherein the precursor vinyl silicone component comprises a molecular weight of at least about 28,000 g/mol.

Embodiment 36. The solventless pressure sensitive adhesive (PSA) or method of any one of embodiments 1, 2, and 3, wherein the precursor vinyl silicone component comprises a molecular weight of not greater than about 72,000 g/mol.

Embodiment 37. The solventless pressure sensitive adhesive (PSA) or method of any one of embodiments 1, 2, and 3, wherein the PSA comprises a vinyl silicone component at a content of at least about 27 wt. %.

Embodiment 38. The solventless pressure sensitive adhesive (PSA) or method of any one of embodiments 1, 2, and 3, wherein the PSA comprises a vinyl silicone component at a content of not greater than about 62 wt. %.

Embodiment 39. The solventless pressure sensitive adhesive (PSA) or method of any one of embodiments 1, 2, and 3, wherein the vinyl silicone component comprises a vinyl terminated polydimethylsiloxane.

Embodiment 40. The solventless pressure sensitive adhesive (PSA) or method of any one of embodiments 1, 2, and 3, wherein the vinyl silicone component comprises a molecular weight of at least about 28,000 g/mol.

Embodiment 41. The solventless pressure sensitive adhesive (PSA) or method of any one of embodiments 1, 2, and 3, wherein the vinyl silicone component comprises a molecular weight of not greater than about 72,000 g/mol.

Embodiment 42. The solventless pressure sensitive adhesive (PSA) or method of any one of embodiments 1, 2, and 3, wherein the crosslinker component comprises a hydride silicone.

Embodiment 43. The solventless pressure sensitive adhesive (PSA) or method of any one of embodiments 1, 2, and 3, wherein the crosslinker component comprises polymethylhydrosiloxane, methylhydrosiloxane-dimethylsiloxane copolymers, trimethylsiloxy-terminated methylhydrosiloxane-dimethylsiloxane copolymers, hydride-terminated, or any combination thereof.

Embodiment 44. The solventless pressure sensitive adhesive (PSA) or method of any one of embodiments 1, 2, and 3, wherein the precursor crosslinker component comprises a molecular weight of at least about 1,000 g/mol.

Embodiment 45. The solventless pressure sensitive adhesive (PSA) or method of any one of embodiments 1, 2, and 3, wherein the precursor crosslinker component comprises a molecular weight of not greater than about 3,000 g/mol.

Embodiment 46. The solventless pressure sensitive adhesive (PSA) or method of any one of embodiments 1, 2, and 3, wherein the PSA comprises a crosslinker component at a content of at least about 0.5 wt. %.

Embodiment 47. The solventless pressure sensitive adhesive (PSA) or method of any one of embodiments 1, 2, and 3, wherein the PSA comprises a crosslinker component at a content of not greater than about 8.0 wt. %.

Embodiment 48. The solventless pressure sensitive adhesive (PSA) or method of any one of embodiments 1, 2, and 3, wherein the crosslinker component comprises a hydride silicone.

Embodiment 49. The solventless pressure sensitive adhesive (PSA) or method of any one of embodiments 1, 2, and 3, wherein the crosslinker component comprises polymethylhydrosiloxane, methylhydrosiloxane-dimethylsiloxane copolymers, trimethylsiloxy-terminated methylhydrosiloxane-dimethylsiloxane copolymers, hydride-terminated, or any combination thereof.

Embodiment 50. The solventless pressure sensitive adhesive (PSA) or method of any one of embodiments 1, 2, and 3, wherein the crosslinker component comprises a molecular weight of at least about 1,000 g/mol.

Embodiment 51. The solventless pressure sensitive adhesive (PSA) or method of any one of embodiments 1, 2, and 3, wherein the crosslinker component comprises a molecular weight of not greater than about 3,000 g/mol.

Embodiment 52. The solventless pressure sensitive adhesive (PSA) or method of any one of embodiments 2 and 3, wherein the solventless pressure sensitive adhesive further comprises a precursor UV activated catalyst component.

Embodiment 53. The solventless pressure sensitive adhesive (PSA) or method of embodiment 52, wherein the precursor UV activated catalyst component comprises bis(acetylacetonato)platinum(II), or trimethyl(methylcyclopentadienyl)(IV).

Embodiment 54. The solventless pressure sensitive adhesive (PSA) or method of embodiment 52, wherein the solventless pressure sensitive adhesive further comprises the precursor UV activated catalyst component at a content of at least about 0.05 wt. %.

Embodiment 55. The solventless pressure sensitive adhesive (PSA) or method of embodiment 52, wherein the solventless pressure sensitive adhesive further comprises the precursor UV activated catalyst component at a content of not greater than about 1.0 wt. % for a total weight of the precursor mixture.

### EXAMPLES

The concepts described herein will be further described in the following Examples, which do not limit the scope of the invention described in the claims.

### EXAMPLES

### Example 1

The following non-limiting examples illustrate embodiments described herein. Samples S1-S4 were prepared according to the process outlined herein. Samples were prepared by coating the pressure sensitive adhesive on to a 1 mil polyimide liner. The cure temperature was 110° C., and the cure time was 2 minutes, respectively.

Property testing of samples S1-S4 was carried out at least 48 hours after initial curing. Tack and Peel strength for each sample were measured as described herein. Results are provided in Table 1 below.

TABLE 1

| | MQ Resin | | Peel Strength - |
|---|---|---|---|
| | Loading (Wt. % for | | 180° Peel Angle |
| Sample | total weight of PSA) | Tack (g) | (N/cm) |
| S1 | 55 | 1011.9 ± 134.3 | 1.41 ± 0.06 |
| S2 | 50 | 553.3 ± 55.6 | 0.77 ± 0.06 |
| S3 | 45 | 294.8 ± 22.6 | 0.37 ± 0.02 |
| S4 | 40 | 160.2 ± 8.2 | 0.16 ± 0.02 |

### Example 2

The following non-limiting examples illustrate the embodiments described herein. Samples S5 and S6 were prepared according to the process outlined herein using a high OH content MQ resin. Comparative sample CS1 and CS2 were prepared according to embodiments described herein except that a low OH content MQ resin was used. Samples were prepared by coating the pressure sensitive adhesive on to a 1 mil polyimide liner. The cure temperature was 110° C., and the cure time was 2 minutes, respectively. Composition and component description are summarized in Table 2 below.

TABLE 2

| | S5 | S6 | CS1 | CS2 |
|---|---|---|---|---|
| Component | (wt. %) | (wt. %) | (wt. %) | (wt. %) |
| Diluent - mono vinyl terminated polydimethylsiloxane | 5% | 5% | 5% | 5% |
| MQ Resin 1 (MW-3200, OH Content - 1.7-2%, M/Q Ratio - 0.6) | 50.00% | 55.00% | — | — |
| MQ Resin 2 (MW-4400, OH Content - 0.5%, M/Q Ratio - 0.8) | — | — | 50.00% | 55.00% |
| Vinyl terminated polydimethylsiloxane | 42.68% | 37.89% | 42.68% | 37.89% |
| Methylhydrosiloxane-dimethylsiloxane copolymer (crosslinker) | 2.22% | 2.01% | 2.22% | 2.01% |
| trimethyl(methylcyclopentadienyl)(IV) | 0.10% | 0.10% | 0.10% | 0.10% |
| Total | 100.00% | 100.00% | 100.00% | 100.00% |

Property testing of samples S5, S6, CS1, and CS2 was carried out at least 48 hours after initial curing. Tack and Peel strength for each sample were measured as described herein. Results are provided in Table 3 below.

TABLE 3

| | | Peel Strength - |
|---|---|---|
| | | 180° Peel Angle |
| Sample | Tack (g) | (N/cm) |
| S5 | 509.0 ± 75.7 | 1.91 ± 0.15 |
| S6 | 978.0 ± 169.5 | 4.18 ± 0.40 |
| CS1 | 535.7 ± 36.9 | 0.88 ± 0.11 |
| CS2 | 815.1 ± 81.2 | 1.68 ± 0.04 |

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A solventless pressure sensitive adhesive (PSA) comprising:
a silicone-based diluent component at a content of at least about 0.1 wt. % and not greater than about 14 wt. % for a total weight of the solventless pressure sensitive adhesive,
an MQ resin component at a content of at least about 30 wt. % and not greater than about 65 wt. % for a total weight of the solventless pressure sensitive adhesive,
a vinyl silicone component at a content of at least about 27 wt. % and not greater than about 62 wt. % for a total weight of the solventless pressure sensitive adhesive, and
a crosslinker component at a content of at least about 0.5 wt. % and not greater than about 8.0 wt. % for a total weight of the solventless pressure sensitive adhesive.

2. The solventless pressure sensitive adhesive (PSA) of claim 1, wherein the PSA comprises a tack of at least about 200 g.

3. The solventless pressure sensitive adhesive (PSA) of claim 1, wherein the PSA comprises a tack of not greater than about 1100 g.

4. The solventless pressure sensitive adhesive (PSA) of claim 1, wherein the PSA comprises a peel strength of at least about 0.2 N/cm as measured at a 180° peel angle.

5. The solventless pressure sensitive adhesive (PSA) of claim 1, wherein the PSA comprises a peel strength of not greater than about 4.2 N/cm as measured at a 180° peel angle.

6. The solventless pressure sensitive adhesive (PSA) of claim 1, wherein the silicone-based precursor diluent component comprises a monovinyl terminated polydimethylsiloxane.

7. The solventless pressure sensitive adhesive (PSA) of claim 1, wherein the precursor diluent component comprises a molecular weight of at least about 5000 g/mol and not greater than about 28000 g/mol.

8. The solventless pressure sensitive adhesive (PSA) of claim 1, wherein the crosslinker component comprises a hydride silicone.

9. A solventless pressure sensitive adhesive (PSA) formed from a solventless pressure sensitive adhesive precursor mixture, wherein the precursor mixture comprises:
a precursor silicone-based diluent component at a content of at least about 0.1 wt. % and not greater than about 14 wt. % for a total weight of the precursor mixture,
a precursor MQ resin component at a content of at least about 30 wt. % and not greater than about 65 wt. % for a total weight of the precursor mixture,
a precursor vinyl silicone component at a content of at least about 27 wt. % and not greater than about 62 wt. % for a total weight of the precursor mixture, and
a precursor crosslinker component at a content of at least about 0.5 wt. % and not greater than about 8.0 wt. % for a total weight of the precursor mixture.

10. The solventless pressure sensitive adhesive (PSA) of claim 2, wherein the precursor MQ resin component has an OH content of at least about 0.3% and not greater than about 2%.

11. The solventless pressure sensitive adhesive (PSA) of claim 2, wherein the precursor MQ resin component has an M/Q ratio of at least about 0.6 and not greater than about 0.8.

12. The solventless pressure sensitive adhesive (PSA) of claim 2, wherein the solventless pressure sensitive adhesive further comprises a precursor UV activated catalyst component.

13. The solventless pressure sensitive adhesive (PSA) or method of claim 12, wherein the precursor UV activated catalyst component comprises bis(acetylacetonato)platinum(II), or trimethyl(methylcyclopentadienyl)(IV).

14. The solventless pressure sensitive adhesive (PSA) or method of claim 12, wherein the solventless pressure sensitive adhesive further comprises the precursor UV activated catalyst component at a content of at least about 0.05 wt. % and not greater than about 1.0 wt. % for a total weight of the precursor mixture.

15. A method of forming a solventless pressure sensitive adhesive (PSA), wherein the method comprises:
providing a solventless pressure sensitive adhesive precursor mixture, wherein the precursor mixture comprises:
a precursor silicone-based diluent component at a content of at least about 0.1 wt. % and not greater than about 14 wt. % for a total weight of the precursor mixture,
a precursor MQ resin component at a content of at least about 30 wt. % and not greater than about 65 wt. % for a total weight of the precursor mixture,
a precursor vinyl silicone component at a content of at least about 27 wt. % and not greater than about 62 wt. % for a total weight of the precursor mixture, and
a precursor crosslinker component at a content of at least about 0.5 wt. % and not greater than about 8.0 wt. % for a total weight of the precursor mixture,
mixing the precursor mixture, and
curing the precursor to form the solventless pressure sensitive adhesive.

16. The method of claim 15, wherein the PSA comprises a tack of at least about 200 g.

17. The method of claim 15, wherein the PSA comprises a tack of not greater than about 1100 g.

18. The method of claim 15, wherein the PSA comprises a peel strength of at least about 0.2 N/cm as measured at a 180° peel angle.

19. The method of claim 15, wherein the PSA comprises a peel strength of not greater than about 4.2 N/cm as measured at a 180° peel angle.

20. The method of claim 15, wherein the solventless pressure sensitive adhesive further comprises a precursor UV activated catalyst component.
